(19) United States
(12) Patent Application Publication
(10) Pub. No.: US 2026/0364549 A1
(43) Pub. Date: Nov. 19, 2026

(54) WHEY END PRODUCT, METHOD AND SYSTEM FOR PRODUCING A WHEY END PRODUCT, AND STIRRING VESSEL FOR FILLING A WHEY END PRODUCT

(71) Applicant: EMMI SCHWEIZ AG, Luzern (CH)

(72) Inventors: Andreas SCHNIDER, Meggen (CH); Jasmin RIEDWEG, Sursee (CH); Thaddäus PERROT, Hildisrieden (CH)

(21) Appl. No.: 19/125,804

(22) PCT Filed: Oct. 24, 2023
(86) PCT No.: PCT/EP2023/079609

§ 371 Date: Apr. 30, 2025

(30) Foreign Application Priority Data
Nov. 4, 2022 (CH) 001308/2022

(51) Int. Cl. B01F 27/192; A23C 21/00; B01F 27/091; B01F 27/84; B01F 35/90; B01F 101/06

(52) U.S. Cl. CPC B01F 27/192; A23C 21/00; B01F 27/091; B01F 27/84; B01F 35/90; B01F 2035/99; B01F 2101/06; B01F 2215/0481

(57) ABSTRACT

A method is described for producing a jellied whey end product. The method produces a whey protein concentrate from a whey where the absolute protein content of the whey protein concentrate adjusts, performs a microparticulation treatment, transfers the hot whey protein concentrate to a receiving vessel with an agitator, and continuously stirs and hot holding of the hot whey protein concentrate in the receiving vessel filling hot whey protein concentrate from the receiving vessel into a final vessel, and cools down the whey protein concentrate in the final vessel to form a jellied whey end product.

### TECHNICAL FIELD OF INVENTION

The present invention relates to a method for producing a whey end product from a whey. It also concerns a plant for producing a whey end product and, in particular, a stirring vessel for filling a whey end product.

### BACKGROUND OF THE INVENTION

During the production of cheese whey is produced as a by-product. It is known from the state of the art to further process the resulting whey, as the whey proteins in particular are easily usable by the human body. Whey is therefore also considered to be nutritionally valuable. For example, the processing of whey into protein powder is known, which is mainly used as a dietary supplement in weight training. Also known is the use of the water-soluble parts of whey as milk serum drinks or the processing of whey into a fat substitute, in which the protein content in the whey is concentrated and processed into inert protein aggregates the size of fat globules. These can mimic the mouthfeel of actual fat in a food. However, the nutritionally high-quality whey proteins in particular are currently mainly used in highly processed form in the food industry, among other things because their high heat sensitivity makes them difficult to process.

### SUMMARY OF THE INVENTION

It is one of the objects of the present invention to provide an alternative method by which whey proteins, which are of high nutritional value to the human body, can be provided as an alternative food.

The object is solved by a method for producing a jellied whey end product, which comprises the following steps:

Provide a whey. From the whey provided a whey protein concentrate is then produced. The resulting whey protein concentrate has an absolute protein content that is in a range from 7% by weight to 27% by weight of whey protein concentrate (g protein/100 g whey protein concentrate).

With the appropriately adjusted whey protein concentrate a microparticulation treatment is carried out. In such a microparticulation treatment, the whey protein concentrate is subjected to a combined treatment of heat and shear, wherein in the present method the temperature is kept continuously high, i.e. not only during but also between different sub-steps. The microparticulation of the whey protein concentrate comprises the following steps: Performing a first combined shear and heat treatment. The first combined shear and heat treatment is carried out at a first microparticulation temperature in a temperature range of 60 °C to 95 °C under continuous shear.

After the first shear and heat treatment, the whey protein concentrate is kept hot at the hot holding temperature in a range of 60 °C to 95 °C and for a hot holding time of sec to 400 sec.

Following the hot holding, a second combined shear and heat treatment is carried out. This is carried out at a second microparticulation temperature of 60 °C to 95 °C under continuous shear.

Following the combined shear and heat treatment, the method according to the invention comprises the following steps: Transfer of the hot whey protein concentrate from microparticulation treatment to a receiving vessel with agitator. In the receiving vessel the still hot whey protein concentrate is continuously stirred and kept hot.

Finally, the still hot whey protein concentrate is filled from the receiving vessel into a final vessel. There, the whey protein concentrate is allowed to cool, causing it to gel in the final vessel to form a whey end product.

In the context of the present invention, whey is understood to be an aqueous residual liquid which is formed during the production of cheese. Depending on the cheese production, a distinction is made between sweet whey and sour whey. Sweet whey (also known as rennet whey) is formed when milk is thickened with rennet for cheese production or whey is separated from the milk by microfiltration. Sour whey is formed when milk is broken down by lactic acid bacteria. The whey provided for the method described here can be a sweet whey or a sour whey. Due to the easier processibility in the method according to the invention, a sweet whey in particular can be used.

It may be provided that before concentration the whey provided is subjected to upstream dedusting, and/or degreasing and/or pasteurization. Such methods are as such known from the prior art and will therefore not be explained further here.

It may also be provided that the whey provided is the direct product of cheese production. Alternatively, it may be envisaged, for example, that a reconstituted whey powder is used for the method. Preferably, the whey is liquid when it is subjected to the concentration step.

In the context of the present invention, it has been surprisingly shown that by exploiting the gel-forming properties of whey proteins, a little processed end product can be produced which contains a high proportion of the nutritionally valuable whey proteins and has a consistency equivalent to that of conventional, firm yoghurts. The present invention specifically uses intently the natural cross-linking property (gelling ability) of heated whey proteins, and according to the invention maintains it until the whey end product is filled into the final vessel. Gelation into the direct, ready-to-consume end product is only permitted in the final vessel or is no longer prevented in the final vessel.

It has been shown that in order to achieve an appropriate degree of gel formation and thus to achieve for consumption the desired consistency and firmness of the end product, the absolute protein content in the whey protein concentrate should be within a defined range. According to the invention, the absolute protein content in the whey protein concentrate is in the range of 7% by weight to 27% by weight.

It has been shown that with a higher employed absolute protein content (i.e. higher than 27% by weight) the time of gelation is impossible or difficult to control, so that the whey protein concentrate gels early—i.e. before filling. The upper limit of the employed protein content can be technically determined by the type of filtration system. It has also been shown that with a lower employed protein content used (i.e. lower than 7% by weight, without the addition of thickeners), the whey protein concentrate does not gel at all or not sufficiently to achieve the desired firmness of the whey end product.

Gelling with a new liquefaction induced during manufacture is not desirable according to the present invention, since an allowed “post-gelling” no longer leads to the desired consistencies of the end product.

In the context of the present invention, the absolute protein content of the whey protein concentrate is understood to be the protein content in the aqueous whey protein concentrate solution. The indication of the absolute protein content of the whey protein concentrate is given in weight percent by weight wt % (g protein per 100 g whey protein concentrate=g/100 g). The absolute protein content in the whey or in the whey protein concentrate solution is determined by the proportion of dry matter in the solution and the proportion of protein in the dry matter.

In the context of the present invention, dry matter (or dry substance) is understood to be the component of an aqueous solution which remains after deduction of the water contained. Dry matter content and water content complement each other to 100%. The dry matter content (TS content) indicates in the context of the present invention the amount of dry matter in weight percent wt % (g per 100 g total substance, e.g. whey or whey protein concentrate).

In the context of the present invention, the protein content in dry matter (also called relative protein content) is understood to be the mass fraction of the protein in the dry matter of the respective substance to be investigated. The protein content in dry matter is given in the context of the present invention in weight percent wt % (g protein per 100 g dry matter=g/100 g). The substance to be investigated can be, for example, the original whey or the whey protein concentrate.

The natural dry matter content of a sweet whey, for example, is about 6 wt %, while the proportion of protein in a sweet whey is about 0.8 wt %. In order to produce a whey end product according to the invention, a whey provided is therefore concentrated and also specifically adjusted according to the invention with regard to the absolute protein content.

The production of a whey protein concentrate from a whey as such is known from the state of the art. By concentrating, an increase in the protein content in the dry matter and an increase in the dry matter content in the whey is achieved. The microparticulation of a concentrated whey is also known, but in the prior art the microparticulate is strongly cooled and sheared after a combined heat and shear treatment in order to achieve inerting of the protein particles and thus prevent the formation of a gel by the whey proteins.

The production of a whey protein concentrate can be done, for example, by means of a filtration step, such as ultrafiltration. Therewith mainly proteins and larger molecules (e.g. bacteria, fat) are retained from the water. If one filtration step is not sufficient to achieve the desired protein content in the whey protein concentrate, it may be envisaged to achieve further concentration in one or more additional filtration steps.

For example, other components, e.g. water-soluble components of whey such as sugar or minerals, can be removed, for example by dilution using diafiltration. By choosing the appropriate filtration processes, both a concentration of the protein content in the dry matter as well as a concentration of the dry matter in the resulting liquid whey protein concentrate can be achieved.

A whey protein concentrate is called because of its protein content in the dry matter. For example, a WPC 60 describes a whey protein concentrate with a protein content in the dry matter of 60 wt %. WPC stands for whey protein concentrate. The following key figure, e.g. 35, 60 or 80, indicates the wt % in g per 100 g dry matter. If the produced concentrate has a protein content in the dry matter of over 90 wt %, for example 95 wt %, such a whey protein concentrate is called WPI (whey protein isolate).

The production of a whey protein concentrate can be a one-step or a multi-step process, as indicated. In a multi-stage process, the whey provided, especially the whey proteins, is gradually concentrated. This can be done on a single, multi-stage filtration plant or on two independent filtration plants. Depending on the protein content to be achieved, it may be, for example, one (or more) ultrafiltration steps and/or one (or more) diafiltration steps, or other purification processes suitable for the concentration to be achieved.

For example, a sweet whey can be concentrated by means of two ultrafiltrations connected in series, first to a WPC 35 and then from WPC 35 to WPC 80. If there is a naturally higher protein content in the dry matter of the whey provided and/or a naturally higher proportion of dry matter, the whey protein concentrate can alternatively be concentrated to a WPC 60 in a one-step process.

The whey protein concentrate with an adjusted protein content is then subjected to a microparticulation treatment. During the microparticulation treatment as well as in the subsequent method steps up to filling, the temperature is according to the invention continuously maintained essentially at or above a denaturation temperature. In addition, according to the invention, the whey protein concentrate is kept in motion continuously. In this way it is ensured that the whey proteins are in a partially denatured state and do not cross-link to form a gel.

For the purposes of the present invention, the denaturation temperature is understood to be the temperature at which the denaturation of whey proteins begins. Amongst experts it is assumed that the denaturation of whey proteins begins at a temperature of around 60 °C. The higher the temperature, the stronger the denaturation can be. Accordingly, the denaturation temperature can be at least 55 °C, for example at least 60 °C. It may be provided that the denaturation temperature is at least 65 °C. It may also be provided that the denaturation temperature is in a range of 60 to 95 °C; it may be provided that the denaturation temperature is a range of 65 °C to 95 °C. It may also be envisaged to achieve a pasteurization effect by means of the denaturation temperature. In this case, it may be provided that the denaturation temperature is not below 70 °C. In this case, it may be provided that the denaturation temperature is not below 75 °C. It may be provided that the denaturation temperature is in a range of 65 °C to 75 °C, for example in a range of 65 °C to 70 °C.

It may be envisaged to influence the degree of denaturation not only by the temperature but also by the time of the temperature exposure: at a lower temperature, the same degree of denaturation can be achieved by a longer temperature exposure compared to a higher temperature with a shorter temperature exposure. The desired gel and/or viscosity properties of the whey end product can then be controlled via the degree of denaturation and the employed absolute protein content in the whey protein concentrate. For example, by a high protein content the temperature and/or the time of temperature exposure can comparatively reduced, while at a rather low absolute protein content a desired gel consistency can still be produced by a corresponding increase of the temperature and/or the time of temperature exposure. In this regard it can be envisaged that in a manufacturing process different temperatures and times are used for different sub-steps.

It may be envisaged to influence the properties of the whey end product, in addition to the degree of denaturation and/or the temperature and/or the time, by the applied scraper rotational speed or the generated intensity of the shear. It should be noted that the time can be linked to the throughput in the plant. It should also be noted that the rotational speed of a scraper can be linked to the throughput in the plant.

Exemplary indications of the temperature exposure time and the applied rotational speed of a scraper usually refer to a plant with a throughput of 200 L-300 L of whey protein concentrate per hour. For plants with a higher throughput, the applied scraper rotational speed is increased, or even additional scrapers are used.

Microparticulation treatment is carried out in a plant that is suitable for exerting high shear forces and temperatures above the denaturation point of whey proteins. A corresponding plant is also called a microparticulation plant in the following. Microparticulation takes place in several sub-steps, in which the whey protein concentrate is subjected to a sequence of combined shear and heat treatments and temperature treatments.

It may be envisaged that, as part of microparticulation, before carrying out combined shearing and heat treatments the whey protein concentrate is first warmed to a heating temperature. Heating can take place, for example, in a heater, such as a plate heat exchanger, a scraped surface heat exchanger or a tube heater. It can be provided that the heating temperature is in a range of 50 °C to 75 °C. It may be provided that the heating temperature is lower than the subsequent temperatures of the microparticulation. For example, the heating temperature can be in a range of 55° to a maximum of 65 °C.

The whey protein concentrate, optionally warmed to a heating temperature, is subjected to an initial shear and heat treatment at an initial microparticulation temperature. For this purpose, the whey protein concentrate can be led from the heater or a tank via pipes to a first scraped surface heat exchanger.

In the first scraped surface heat exchanger, heating to the first microparticulation temperature takes place. The first microparticulation temperature is in a range of 60 °C to 95 °C. Under the influence of continuous temperature exposure, a combined shear treatment is carried out. This can be, for example, by a continuously rotating blade in the first scraped surface heat exchanger. For example, an ASA type scraped surface heat exchanger from the company SPX is suitable.

As an example, a suitable first microparticulation temperature of 80 °C+/−1 C for a WPC 80 is mentioned.

Due to the influence of heat, the whey proteins are denatured or folded up. The shear causes the unfolded proteins to be sheared into particles of a certain size range. It may be envisaged that the target size range is in a range of 0.5 μm to 50 μm.

It may be envisaged that the degree of denaturation of the whey proteins can be influenced not only by the temperature, but also by the treatment time of the first combined shear and heat treatment. For example, in an exemplary plant with a throughput of 200 L of whey protein concentrate per hour (h), the treatment time may be in the range of 30 sec (seconds) to 5 min (minutes), with a shorter treatment time at higher temperatures.

After the first combined heat and shear treatment, the whey protein concentrate is subjected to a hot holding phase. In this step, the quality of the whey end product is significantly influenced, for example in terms of viscosity and thickening behavior.

The hot holding temperature is in the range of 60 °C to 95 °C with a hot holding time of sec to 400 sec. Again, at a lower temperature, the hot holding time must be longer, while at a higher temperature, the hot holding time may be shorter. Accordingly, it may be provided that the hot holding temperature is at least 55 °C if the hot holding time is adjusted accordingly. It can also be provided that the hot holding time is adapted to the throughput of the plant used.

It may be envisaged that hot holding takes place, for example, in a hot holding section by which the first scraped surface heat exchanger is connected to a subsequent, second scraped surface heat exchanger for the second combined shear and heat treatment. It may also be provided that a hot holder used does not provide for active heating of the whey protein concentrate, but that the temperature of the whey protein concentrate is passively determined, for example, by the length, cross-section and flow rate as well as by the temperature of the whey protein concentrate from the first scraped heat exchanger directly upstream of the hot holder. In this case, the hot holding temperature at the beginning of the hot holding section corresponds to the first microparticulation temperature, while the temperature is not further adjusted or checked during the hot holding section. It may be envisaged that the dimensioning of the pipe and/or the throughput ensures that the temperature of the whey protein concentrate drops by a maximum of 10 °C during the hot holding phase, for example by a maximum of 6 °C.

Alternatively, it can be envisaged to actively bring the whey protein concentrate to a hot holding temperature by means of a heating unit. In this case, the hot holding temperature can be adjusted independently of the microparticulation temperature.

During this hot holding phase, the whey protein concentrate does not undergo active shear, although it may be moved. Here, the aggregation of the unfolded whey proteins is permitted.

For an exemplary whey protein concentrate WPC 80 with a dry matter content of 23 wt % and a fruit preparation of 15.1%, a suitable hot holding time of 60 seconds has been found at an output of 200 L/h.

After hot holding, the still hot whey protein concentrate is subjected to a second combined shear and heat treatment at a second microparticulation temperature under continuous shear. The second microparticulation temperature is in a range of 60 °C to 95 °C. It may be envisaged that the second micropistulation temperature differs from the first microparticulation temperature, or that it is substantially the same. It may be provided that the second microparticulation temperature is lower than the first microparticulation temperature. For example, the whey protein concentrate may be allowed to experience a temperature loss of a few degrees Celsius due to transport in the hot holding section. In this case, the second microparticulation temperature can be lower than the first microparticulation temperature by a temperature of 1 °C to 10 °C, for example from 3 °C to 6 °C. It may be envisaged that the second microparticulation temperature is so high that the degree of denaturation of the whey proteins will continue to increase.

Alternatively, it can be provided that the second micropistulation temperature is above the first microparticulation temperature. Alternatively, it may be provided that the second microparticulation temperature is essentially the same as the hot holding temperature.

The second combined shear and heat treatment can be carried out in a second scraped surface heat exchanger, in which heating to the second microparticulation temperature is carried out in combination with a shear treatment. The treatment time can be selected based on the applied temperature and the absolute protein content of the whey protein concentrate, as explained above. It may be provided that the treatment time is specified by the plant. For example, a treatment time in a range of 30 seconds to 5 minutes is mentioned.

For example, an ASA type scraped surface heat exchanger from the company SPX is suitable.

It is assumed that in this second combined shear and heat treatment, the formation of larger aggregates of unfolded proteins is prevented and whey protein aggregates formed by hot holding are brought into a desired size range, while the proteins are still in a partially denatured state. This results in a more uniform structure of the whey end product that is later gelled.

It may be envisaged to adjust the particle size by means of the first and second combined shear treatment to a size range of 0.5 μm to 1000 μm, preferably from 0.5 μm to 50 μm. It may be possible to adjust the particle size to a size range of 0.5 μm to 20 μm, or from 0.5 μm to 15 μm.

After the second combined shear and heat treatment or after microparticulation, the still hot, microparticulated whey protein concentrate is transferred to a receiving vessel that is part of a filling plant or itself includes a filling mechanism. In the receiving vessel the whey protein concentrate is kept so hot that its temperature is kept at least above a minimum temperature. It may be envisaged that the temperature of the whey protein concentrate is maintained above the denaturation temperature. In addition, the whey protein concentrate is continuously stirred in the receiving vessel (it is therefore alternatively referred to as a stirring vessel in the following). By hot holding above a minimum temperature and stirring continuously, the formation of a gel-like cross-linking of the whey proteins is delayed, so that the time of gelation is controlled in view of the cooling process in the final vessel.

It may be envisaged to limit the length of stay of the whey protein concentrate until filling. This may be provided for in particular if the receiving vessel itself does not include active heating or temperature control. This results in a maximum storage period during which it is ensured that no gelation of the whey protein concentrate takes place.

It may be provided that whey protein concentrate is continuously filled into the receiving vessel while simultaneously whey protein concentrate is being filled at the same time. In this situation, a continuous mixing of new, hotter whey protein concentrate with the whey protein concentrate already in the vessel takes place. Depending on the power of the plant, the stay time can range from a few seconds to 20 min, for example in the range from 1 min to 15 minutes.

It may be provided that the receiving vessel is preheated to a minimum temperature immediately before the hot, microparticulated whey protein concentrate is poured. For example, it can be tempered to a denaturation temperature. Alternatively, the receiving vessel can be preheated to a lower temperature than the denaturation temperature. This may be provided for in particular if the whey protein concentrate itself has a high temperature and though it cools down in the receiving vessel it does not cool below a temperature at which gelation begins due to its high temperature and an adapted stay time in the receiving vessel.

In addition, or alternatively, it may be provided that the receiving vessel is actively heated in order to maintain the desired temperature of the microparticulated whey protein concentrate in the receiving vessel, or to maintain the preheating temperature of the receiving vessel.

The receiving vessel includes an agitator for continuous stirring. The more homogeneous and even the stirring, the longer the whey protein concentrate can remain in the receiving vessel until it has to be filled—the longer the gelling ability of the hot whey protein concentrate can be maintained before filling. For example, a volume of 30 litres (L) of whey protein concentrate can be held in a receiving vessel with a capacity of 40 litres and at a temperature of 70 °C for a period of up to 10 minutes before being filled into a final vessel for the first gelling.

The filling of the still hot, microparticulated whey protein concentrate takes place from the receiving vessel directly into the final vessel, in which the whey protein concentrate is stored as a whey end product and made available for consumption. In this final vessel, the whey protein concentrate can cool down. With decreasing temperature and in the absence of movement, the whey protein concentrate eventually gels into the whey end product. For filling, the receiving vessel itself can include a filling mechanism, e.g. a filling head, or be fluidically connected to a filling mechanism of a filling plant.

Depending on the protein content used and/or the treatment temperature and/or the intensity of the stirring and/or treatment time during production, the gelation results in a whey end product, which preferably has a consistency comparable to the consistency of firm yoghurt.

It is envisaged that the following consistency categories of the whey end product are achieved by means of the method of the invention:
1 barely gelling, liquefies very quickly, even under slight shear (e.g. by simply stirring with a spoon);
   This consistency can be achieved, for example, by:
   Mixing of whey protein concentrate WPC 80 (85 wt %) with a fruit preparation (15 wt %), acidulating; subsequent microparticulation at an output of 200 L/h, a first microparticulation temperature of 76 °C, a rotational speed of the first scraped surface heat exchanger of 200 rpm (revolution per minute), a hot holding time of 60 sec, and a second microparticulation temperature of 72 °C, a rotational speed of the second scraped surface heat exchanger of 200 rpm, homogenization with 100 bar and subsequent filling.
2 comparable to firm yoghurt, but liquefies after stirring several times with a spoon;
   This consistency can be achieved, for example, by:
   Mixing of a whey protein concentrate WPC 80 (85 wt %) with a fruit preparation (15 wt %), acidulating; subsequent microparticulation at a output of 200 L/h, a first microparticulation temperature of 76 °C, a rotational speed of the first scraped surface heat exchanger of 500 rpm; a hot holding time of 60 sec, and a second microparticulation temperature of 72 °C, a rotational speed of the second scraped surface heat exchanger of 500 rpm, homogenization with 100 bar and subsequent filling.
3 slightly more firm than category 2, liquefies only when stirred intensively with a spoon (e.g. stir for 15 seconds); melts only slowly at room temperature (e.g. after 1 h);
   This consistency can be achieved, for example, by:
   Mixing of a whey protein concentrate WPC 80 (85 wt %) with a fruit preparation (15 wt %), acidulating; subsequent microparticulation at a output of 200 L/h, a first microparticulation temperature of 80 °C, a rotational speed of the first scraped surface heat exchanger of 500 rpm, a hot holding time of 60 sec, and a second microparticulation temperature of 76 °C, a rotational speed of the second scraped surface heat exchanger of 500 rpm, homogenization at 100 bar and subsequent filling.
4 firm, only slightly elastic, consistency comparable to soft butter (room temperature); retains its shape outside the refrigerator for several hours (e.g. 2 h); visually hardly distinguishable from category 3, disintegrates into smaller pieces of gel when stirred intensively with a spoon, which are difficult to mix into a homogeneous mass.
   This consistency can be achieved, for example, by:
   Mixing of a whey protein concentrate WPC 80 (85 wt %) with a fruit preparation (15 wt %), acidulating; subsequent microparticulation at a output of 200 L/h, a first microparticulation temperature of 80 °C, a rotational speed of the first scraped surface heat exchanger of 700 rpm, a hot holding time of 60 sec, and a second microparticulation temperature of 76 °C, a rotational speed of the second scraped surface heat exchanger of 700 rpm, homogenization with 100 bar and subsequent filling.

Based on this classification, a whey end product can be assessed visually and/or sensorially. Such an assessment is easier than a rheometric measurement, which cannot be performed on the end product, as the whey protein concentrate solidifies immediately once it is in the measuring container.

In an embodiment, it is not intended to produce a whey end product with the consistency of a yoghurt drink.

The present method makes it possible to produce from a whey protein concentrate a direct, ready-to-eat and nutritionally high-quality product in a technically practicable manner in terms of plant design. The quantities given for the whey protein concentrate are directly transferable to the end product. With range indications the range-limiting values are always included.

According to the method described here, the whey product is kept in a gelling state until bottling. Immediately after filling into the final container, the gelation process is then permitted by adjusting the heat influence and movement of the whey protein concentrate. Only in the final container does the gelling of the heat- and shear-treated whey protein concentrate take place and thus the transition into the ready-to-consume whey end product. This means that the manufacturing process must be closely coupled with the filling process—there is no provision for intermediate storage, for example, in a cooling tank before filling or any other cooling of the gellable whey protein concentrate during production.

It has been shown that if the whey protein concentrate microparticulate has already gelled before it has been filled, it is possible to trigger a further gelation by heating and shearing the gelled microplicate again. However, the same firmness cannot be achieved in the end product as when the microparticle gels for the first time in the final product. Therefore, gelation of the microparticulate before it is filled into the final vessel is not desirable and is deliberately prevented by continuous hot holding and moving.

In an embodiment of the method according to the invention, which can be combined with any embodiment already mentioned and mentioned below, unless there is a contradiction, the whey is a sweet whey.

The use of sweet whey has the particular advantage that the production of a whey protein concentrate has been tested. On the other hand, the production of a whey protein concentrate from sour whey is energetically rather inefficient, as it requires additional processing steps such as filtration processes.

In an embodiment of the method according to the invention, which can be combined with any embodiment already mentioned and mentioned below, unless there is a contradiction, the whey protein concentrate is produced by means of a process selected from ultrafiltration, diafiltration, microfiltration and ion chromatography, or a combination thereof.

Depending on the initial whey and/or concentration to be achieved, the appropriate process or a combination thereof may be used.

In an embodiment of the method according to the invention, which can be combined with any embodiment already mentioned and mentioned below, unless there is a contradiction, the first combined shear and heat treatment is carried out in a first scraper heat exchanger at a scraper rotational speed in a range of 100 rpm to 1200 rpm at a volume throughput in a range of 150 L/h to 600 L/h (rpm=revolutions per minute; L/h=litres per hour). In addition, the second combined shear and heat treatment is carried out in a second scraped surface heat exchanger at a scraper rotational speed in a range of 100 rpm to 1200 rpm with a volume throughput in a range of 150 L/h to 600 L/h.

It may be provided that the scraper rotational speed of the first scraped surface heat exchanger and the scraper rotational speed of the second scraped surface heat exchanger are the same for the same volume throughput. Alternatively, it may be provided that the scraper rotational speed of the first scraped surface heat exchanger differs from the rotational speed of the second scraped surface heat exchanger.

By selecting the scraper rotational speed, the consistency of the whey end product can be influenced in addition to the temperature and the specific absolute protein content (and, if applicable, the relative protein content) of the whey protein concentrate. The following applies: the higher the scraper rotational speed, the thicker the sample becomes.

In one embodiment, it may be provided that the method according to the invention is to be carried out in a larger plant, which can, for example, handle a volume throughput of up to 3000 L/h. It is in the knowledge of a skilled person to adjust the scraper rotational speed accordingly in the event of changed volume throughputs in order to produce the whey end product according to the invention.

In an embodiment of the method according to the invention, which can be combined with any embodiment already mentioned and mentioned below, unless there is a contradiction, the first microparticulation temperature lies in a range of 69 °C to 89 °C.

In an embodiment of the method according to the invention, which can be combined with any embodiment already mentioned or mentioned below, unless there is a contradiction, the first microparticulation temperature and/or the second micropistulation temperature and/or the hot holding temperature differ from each other by a maximum temperature range of 10 °C, preferably by a maximum temperature range of 5 °C.

In an embodiment of the method according to the invention, which can be combined with any embodiment already mentioned and mentioned below, unless there is a contradiction, the microparticulation treatment additionally comprises: Performing a pre-microparticulation which includes a combined shear and heat pre-treatment after heating the whey protein concentrate to the denaturation temperature and before performing the first combined shear and heat treatment, wherein the pre-microparticulation is performed at a pre-treatment temperature between 60 °C and 95 °C under continuous shear.

It may be envisaged that the pre-microparticulation is carried out for a period of time in a range of 30 sec to 5 min.

For achieving a uniform consistency of the whey end product it can be advantageous to carry out three consecutive combined shear and heat treatments.

In an embodiment of the method according to the invention, which can be combined with any embodiment already mentioned and mentioned below, unless there is a contradiction, the pre-treatment temperature differs
by a maximum temperature range of 10 °C, preferably by a maximum temperature range of 5 °C from the heating temperature, and/or
by a maximum temperature range of 20 °C, preferably 15 °C from the first microparticulation temperature.

It may be provided that though the pre-treatment temperature deviates from the heating temperature and/or the first microparticulation temperature, it is at least 60 °C, preferably at least 65 °C. In this way, it can be ensured that during microparticulation after heating, the whey proteins are kept in the process of denaturation and unfolding.

The pre-microparticulation is carried out in a separate pre-scraped surface heat exchanger upstream of the first scraped surface heat exchanger. It may be envisaged that the pre-microparticulation is carried out at a scraper rotational speed in a range of 100 rpm to 1200 rpm with a volume throughput in a range of 150 L/h to 600 L/h.

In an embodiment of the method according to the invention, which can be combined with any embodiment already mentioned and mentioned below, unless there is a contradiction, the whey protein concentrate is homogenized after microparticulation and before transfer to the receiving vessel.

Homogenization can be performed between the second combined shear and heat treatment and the transfer into a receiving vessel. Here, too, the requirement is that the microparticulated whey protein concentrate is kept above the denaturation temperature. In this way, the whey protein concentrate shall continue to be kept in a gelling state. This means that the microparticulated whey protein concentrate is still kept hot. Homogenization of whey protein concentrate microparticulate that is still gellable is advantageous in order to postpone the gelation process to the final vessel.

It may be envisaged to use a commercially available homogeniser for homogenisation. It may also be envisaged to apply a homogenisation pressure in a range of 80 bar to 150 bar or up to 250 bar. It should be noted that the homogenization pressure applied depends on the homogenizer used. The homogenisation pressure to be applied can therefore be adjusted to the usual height by a skilled person.

It has been found that a homogenization step can achieve a smoothing of the microparticulated whey protein concentrate, wherein the protein agglomerates are aligned with each other. Any lumps that may have formed in the plant can be loosened. With the help of the homogenization step, the firmness of the whey end product can therefore also be checked. In an embodiment without a homogenization step, a similar effect can be achieved, for example by increasing the temperature or shear treatment.

In an embodiment of the method according to the invention, which can be combined with any embodiment already mentioned and mentioned below, unless there is a contradiction, the whey protein concentrate from the microparticulation is kept at a temperature in a range of 60 °C to 95 °C, preferably in a range of 70 °C to 85 °C, until it is transferred to the receiving vessel, preferably until filling.

This specification ensures that the whey protein is kept in a gellable state from microparticulation onwards, and that the (first) gelation only takes place when it cools in the final vessel into the whey end product.

It may be provided that the receiving vessel is a stirring vessel with an agitator.

In an embodiment, it may be provided that the cooling of the whey end product in the final vessel is checked. For example, checking can be carried out by setting the corresponding ambient temperature. The whey end product can then cool down to the ambient temperature without any further measures. For example, it may be envisaged to set the ambient temperature to 6 °C or lower. In particular, it may be envisaged that cooling takes place within 11 h, for example, to 6 °C or lower. In this way, it is possible to prevent spores that may be present from growing in the whey end product.

In an embodiment of the method according to the invention, which can be combined with any embodiment already mentioned and mentioned below, unless there is a contradiction, the absolute protein content of the whey protein concentrate is adjusted depending on the protein content in the dry matter (g/100 g dry matter) and the proportion of dry matter in the whey protein concentrate, wherein the protein content in dry matter is in the range of 60 wt % to 95 wt %.

By producing a WPC 60 to WPI whey protein concentrate, the protein content in the dry matter can be increased. When concentrating, the proportion of dry matter itself is also increased. The absolute protein content to be used for the present method is obtained by adjusting the protein content in the dry matter and the dry matter content in the whey protein concentrate.

If there is a very high protein content in the dry matter, the proportion of dry matter in the whey protein concentrate may be correspondingly smaller in order to achieve comparable properties in the whey end product.

Accordingly, a whey provided must be measured in terms of the protein content in the dry matter and the proportion of dry matter in the whey. Based on the specific properties of the whey provided, as well as the optional additives to be used, such as acidifiers and flavourings, it can then be determined to what extent the protein content in the dry matter and the proportion of dry matter itself must be increased. It is important to consider the extent to which the additives, such as flavorings, contribute to the dry matter and/or protein content. Adjusting the whey protein concentrate is done in such a way that the absolute protein content to be achieved is given in the whey protein concentrate or the whey protein concentrate mixture (which is obtained by adding the optional additives) as it is transferred to microparticulation.

The whey protein concentrate used in microparticulation can be the pure whey protein concentrate or a whey protein concentrate mixture that includes the pure whey protein concentrate and other additives such as water, acidifiers or flavorings. The absolute protein content is present in the whey protein concentrate as it is transferred to microparticulation. This means that when adjusting, any dilution effects caused by additives are taken into account.

For example, a basic ingredient (a flavoring preparation) consisting of 26.7 wt % of mango puree, 16.4 wt % of passion fruit puree, 0.2% of lemon juice concentrate, 56.2% granulated sugar, and 0.6% of maracuja flavoring can be mixed 15.1 wt % with a whey protein concentrate with a fat content of 1.7 wt %, a protein content of 19.2 wt %, a dry matter of 23.6 wt % and a pH of 6.05. By adding 0.5 wt % of lemon juice concentrate, the pH of the mixture can be lowered to 5.1.

Typically, additives to flavoring preparations tend to have a low or almost no protein content worth mentioning, but have an influence on the dry matter. Dilution effects due to additives can be balanced, for example, by playing with temperature and/or shear and, if necessary, in comparison with existing whey protein concentrates.

It may be provided in an embodiment that the dry matter content in the whey protein concentrate is in the range of 10 wt % to 30 wt %. It is possible that the dry matter content in the whey protein concentrate is in a range of 15 wt % to 25 wt %, for example in a range of 20 wt % to 24 wt % for a WPC 80.

In an embodiment of the method according to the invention, which can be combined with any embodiment already mentioned and mentioned below, unless there is a contradiction, the absolute protein content of the whey protein concentrate is in a range of 10 wt % to 20 wt %, especially preferably in a range of 16 wt % to 20 wt %.

In an embodiment of the method according to the invention, which can be combined with any embodiment already mentioned and mentioned below, unless there is a contradiction, the whey protein concentrate is acidulated to a pH value between 3 and 6.5 before the microparticulation treatment, wherein acidulation is carried out by adding an acidifier.

Acidulation can achieve additional thickening of the whey protein concentrate. Acidulation can also have a beneficial effect on the taste of the whey end product. Whey protein concentrate alone can have a slightly alkaline taste, which is softened by acidulation. It may be envisaged to adjust the whey protein concentrate to a pH between 4.8 and 5.2. The pH value is given for the whey protein concentrate as it is fed into the microparticulation treatment. The pH value is adjusted accordingly for recipes with the whey protein concentrate, i.e. for example for mixtures with flavorings such as fruit puree or similar.

In an embodiment of the method according to the invention, which can be combined with any embodiment already mentioned and mentioned below, unless there is a contradiction, the acidifier is selected from a group comprising: citric acid, citric acid concentrate, lactic acid, malic acid, phosphoric acid, acetic acid, nitric acid.

In an embodiment of the method according to the invention, which can be combined with any embodiment already mentioned and mentioned below, unless there is a contradiction, the acidifier is a micro-organism culture, and acidulation involves an incubation of the whey protein concentrate with the micro-organism culture.

A microorganism culture can be a monoculture or a mixed culture. A microorganism culture can be a well-known yogurt or quark culture. Exemplary microorganisms are lactic acid bacteria, such as Lactobacillus bulgaricus and Streptococcus thermophilus or mixtures thereof.

In an embodiment of the method according to the invention, which can be combined with any embodiment already mentioned and mentioned below, unless there is a contradiction, one or more flavoring substances are added to the whey protein concentrate before microparticulation. Such flavors are selected from a group that includes: sugar, sweetener, fruit puree and flavorings.

Flavorings can be, for example, sweeteners, sugar or sugars such as caramel sugar syrup, glucose syrup, maltodextrin, honey, agave syrup and preparations thereof.

Flavoring substances can be flavorings, natural flavorings, flavoring substances, flavoring extracts, artificial flavors, or combinations thereof, for example cocoa powder, chocolate powder, chocolate flavoring, coffee flavoring, or fruit flavoring, e.g. of citrus fruit, stone fruit, exotic fruits; caramel flavor, coconut flavor. Sour, spicy, salty or bitter aromas are also possible. Flavorings can also be used as a concentrate and, if necessary, have an acid component.

It may be envisaged that the flavoring or flavorings are a semi-finished product that has already been preserved and is made up of various ingredients. It may be envisaged that the flavoring or flavorings have been pasteurized beforehand.

The whey protein concentrate is subjected as a whey protein concentrate mixture to the microparticulation process with the optional flavorings and the optional acidifiers.

Mixing can be carried out in a separate mixing tank, which is directly connected to a heater of a downstream microparticulation plant, for example, or which is initially connected to an intermediate supply vessel for the heater for simplified dosing.

The amount of optional flavorings and/or optional acidifiers and/or an optional additional fat source may be limited by the requirement of the absolute protein content to be used in the whey protein concentrate fed to micropisticulate.

In an embodiment of the method according to the invention, which can be combined with any embodiment already mentioned and mentioned below, unless there is a contradiction, the proportion of one or more flavorings in a whey protein concentrate mixture which is subjected to microparticulation is between 0 wt % and 35 wt %, the lower limit preferably being 1% by weight, and the upper limit preferably being 30% by weight, particularly preferably 20 wt %.

These proportions refer to the resulting mixture of whey protein concentrate and flavorings (and optional acidifier, fat source) as it is fed into microparticulation.

In an embodiment of the method according to the invention, which can be combined with any embodiment already mentioned and mentioned below, unless there is a contradiction, the fat content in the whey protein concentrate as it is subjected to microparticulation is in the range of 0.7 wt % by weight to 30 wt %.

It may be envisaged that whey or whey protein concentrate should not be specifically supplemented with fat. The natural fat content of a whey defatted by centrifugation is about 0.1 g per 100 g of whey. By concentrating the whey proteins during the production of the whey protein concentrate, there is also an inherent concentration of the fat content.

If a higher fat content is desired, which cannot be achieved by the concentration process, it may be provided that this can be achieved by adding fat. One possible source of fat that can be added is cream, for example.

If a lower fat content is desired than that achieved by the concentration process of the whey proteins, it may be envisaged to separate the fats contained in the whey from the protein fraction, for example by means of microfiltration, and thus reduce the fat content.

In practice, complete de-fatting is not possible. The limit value of 0.1 wt % therefore refers to a technically feasible lowest fat content in the liquid whey protein concentrate produced, for example by means of ultrafiltration.

Possible fat additives to increase the fat content are, for example, cream, vegetable fats, vegetable oils, fat emulsions or the like.

The fat content indication refers to the whey protein concentrate as it is transferred to microparticulation. It can therefore be the pure whey protein concentrate if the whey is to be processed into the whey end product without additives. If additives are added to the whey protein concentrate as mentioned above, the fat contents indicated refer to the mixture of the whey protein concentrate with the additives used in each case.

It is an advantage of the present invention that a consumable whey end product is produced which does not require the addition of a thickener. Consistency can essentially be controlled by adjusting the absolute protein content, heat influence, and motion in a way that is technically practicable in terms of plant design.

In an embodiment of the method according to the invention, which can be combined with any embodiment already mentioned and mentioned below, unless there is contradiction, one or more of the following parameters are adjusted to produce a whey end product according to one of the previously presented categories 1 to 4:
The absolute protein content in the whey protein concentrate. This is in a range of 7 wt % to 27 wt % of whey protein concentrate. It may be envisaged that the absolute protein content is in a range of 10 wt % to 20 wt %, for example in a range of 16 wt % to 20 wt %. It has been shown that adjusting the absolute protein content has a significant influence on the consistency or gel formation of the whey end product.

It has been shown that a WPC with a higher protein content and dry matter content (i.e. a higher absolute protein content) already forms a gel at a lower temperature compared to a WPC with a lower protein and dry matter content (i.e. a lower absolute protein content). It has been shown that the effect of the absolute protein content on gel formation dominates an effect of the protein content in the dry matter.
The dry matter content in the whey protein concentrate. This is in a range of 10 wt % to 30 wt %, for example in a range of 15 wt % to 25 wt %.

It has been shown that the dry matter content has an influence on triggering gel formation. For example, it has been shown that with the same absolute protein content of two WPCs, the one thickens earlier with increasing temperature that has a higher dry matter content.
The pH of the whey protein concentrate, which is in a range of 3 and 6.5.

It has been shown that a lower pH leads already at lower temperatures to the formation of a gel. It may therefore be intended to control gel formation by means of the pH value.
The temperatures of the microparticulation, which is in a range of 60 °C to 95 °C, preferably in a range of 60 °C to 89 °C.

As mentioned, it has been shown that in whey protein concentrates with a relatively lower absolute protein content, increasing the temperature can trigger gel formation, while for a similar consistency of a whey end product, a whey protein concentrate with a higher protein content can reduce the temperature (and the time of temperature exposure).

It may be envisaged that the temperature is adjusted not only with regard to the gelation of the whey protein concentrate, but also with regard to microbiological effects. By means of a sufficiently high temperature, a pasteurization effect can be achieved. In this case, the temperature is at least 70 °C, especially at least 75 °C.

In an embodiment, in addition to the absolute protein content and/or the dry matter content, and/or the temperature(s) in the microparticulation and/or the pH value, it may be provided to control the gelation by means of the rotational speed of the scrapers used in the microparticulation. The areas described above are applicable here. It may be envisaged, for example, that due to plant requirements one or more of these parameters are used in order to achieve a desired consistency of the whey end product. It should be noted that if, for example, one of these parameters is changed, another parameter may also be adjusted. The relation is described here.

In one embodiment, it may be envisaged that the whey protein concentrate is conveyed to microparticulation without lactose, e.g. by means of an enzymatic treatment.

One aspect of the invention also relates to a whey end product produced by a method according to one of claims 1 to 16. The whey end product corresponds to one of the previously presented categories 1 to 4.

Whey end products of conventional microparticulation treatments are often characterized by a sandy or topping mouthfeel. In contrast, whey end products produced according to the method of the invention are characterized by a softer mouthfeel. Although the particles in a whey end product produced according to the invention are comparatively larger, they are enclosed in a product matrix so that they are not or less disturbingly perceptible to the senses.

One aspect of the invention relates to a plant for the production of a whey end product, for example in an embodiment as described above. Such an plant includes:
a device for producing a whey protein concentrate;
a microparticulation device; and
a filling device with a stirring vessel for filling the final whey product.

The plant also includes pipes connecting the device for producing a whey protein concentrate, the microparticulation device and the filling device in that order.

The plant is characterized by the fact that it is designed to keep a whey protein concentrate at a temperature in a range of 60 °C to 95 °C during microparticulation until filling.

It may be envisaged that the individual elements of the plant are controlled by means of a control system, for example with regard to the tempering control, shearing and transport of the whey or whey protein concentrate. It may be provided that control is provided by a computer.

A device for producing a whey protein concentrate may be, for example, an ultrafiltration plant, a diafiltration plant, a microfiltration plant or a plant for performing ion chromatography, or a combination of one or more of these plants. One example is an ultrafiltration plant from the company SPX from the LeanCream™ method. Especially for the production of whey protein concentrates with higher protein contents in dry matter, it is envisaged to combine ultrafiltration, e.g. with diafiltration, in order to achieve further concentration. Accordingly, the device for producing a whey protein concentrate includes an ultrafiltration plant with diafiltration steps, so that the whey is brought to the desired concentration in a—in this case—combined process.

A microparticulation device is designed to perform a microparticulation treatment as described above. Depending on the number and sequence of combined shear and heat treatments and heat treatments, the microparticulation device comprises a corresponding number of heating elements (such as plate or tubular heat exchangers or other heating elements), scraped surface heat exchangers and hot holding sections.

Optionally, the microparticulation device comprises a plant for heating or preheating the whey protein concentrate to the denaturation temperature. It may be envisaged that this plant comprises temperature sensors for determining the temperature of the whey protein concentrate being filled in or passing through, and that the control system controls the temperature in order to bring the whey protein concentrate to the desired temperature.

In particular, the microparticulation device comprises at least two scraped surface heat exchangers. In this case, a first scraped surface heat exchanger is with respect to piping connected to the optional heater in such a way that the heated whey protein concentrate is transported from the heater into the scraped surface heat exchanger without its temperature falling below the denaturation temperature. In the first scraped surface heat exchanger, the first combined shear and heat treatment described above is then carried out. The first scraped surface heat exchanger is connected to the second scraped surface heat exchanger via a hot holder.

A scraped surface heat exchanger is as such known from the state of the art. An exemplary scraped surface heat exchanger, as it can be used according to the invention, is, for example, an ASA (APV Shear Agglomerator) scraped surface heat exchanger from the company SPX. Such a scraped surface heat exchanger can be used as a first and/or second scraped surface heat exchanger and/or also as a pre-scraped surface heat exchanger. Such a scraped surface heat exchanger comprises a rotatable blade and a heating unit. By quickly turning the knife under the influence of heat, the proteins of the whey protein concentrate that have unfolded under the influence of heat are sheared.

By controlling the shear speed and the influence of heat, the resulting particle size of the agglomerated whey proteins can be controlled.

For example, the heat holder can be a simple hot holding section. These can be pipes designed in such a way that the temperature of the transported whey protein concentrate from the first scraped surface heat exchanger does not drop by more than, for example, 6 °C or below 60 °C, as mentioned. This can be done passively by adjusting the length and diameter of the pipes to the temperature from the first shear and heat treatment, so that some temperature loss is taken into account. However, it may be envisaged to install an actively heating holding cell in such a passive line, so that, for example, the whey protein concentrate is actively heated halfway through.

The scraped surface heat exchangers used are designed to meet the scraper rotational speeds and temperatures described above for the respective combined shear and heat treatment.

The filling device for filling the whey end product comprises a stirring vessel that is designed to pre-store the hot, microparticulated whey protein concentrate until it is filled and to maintain its gelling ability. The stirring vessel can be a receiving vessel described above.

In particular, the pipes connect the device for producing the whey protein concentrate, the microparticulation device and the stirring vessel of the filling plant to each other in this order.

An important aspect of the present invention is that including the microparticulation device and the downstream plants and pipes are designed to continuously maintain the temperature of the whey protein concentrate at or above the denaturation temperature. In this case, continuous means that at no point in the manufacturing process and thus when the whey protein concentrate passes through the plant and its individual elements can the whey protein concentrate cool below the denaturation temperature. The system is designed in such a way that the desired temperature of the whey protein concentrate is kept active or passive. Only after filling into the final vessel is there no deliberate influencing of the temperature to keep it hot, but the filled whey protein concentrate is left to its own devices and can thus cool down. Until filling, cooling below the denaturation temperature is deliberately prevented.

The plant is therefore suitable for the production of a whey end product in an embodiment described here.

In an embodiment of the plant according to the invention, which can be combined with any embodiment already mentioned and mentioned below, unless there is a contradiction, the plant also comprises a homogenizer, which is arranged between the microparticulation device and the stirring vessel and connected to them by pipes.

A further aspect of the invention relates to a stirring vessel for a plant as described above. The stirring vessel, also known as the receiving vessel, comprises one or more functionally integrated agitators. It may be provided that the stirring vessel comprises at least two agitators that can be rotated in opposite directions. Each agitator can be rotated around its own axis of rotation. It may be provided that the rotation axes of the individual agitators are different, or it may be provided that the rotation axes of the individual agitators are identical. In the latter case, the agitators can be rotated around a common axis of rotation.

Thanks to the counter-rotating agitators, the hot, microparticulated whey protein concentrate can be stored for a certain period of time until it is filled into the final vessel and still be kept in a gellable state.

In an embodiment of the stirring vessel according to the invention, which can be combined with any embodiment already mentioned and mentioned below, unless there is a contradiction, a first agitator is designed as a cup agitator. In addition, a second agitator includes at least one scraper, which can be rotated around the first axis of rotation. To prevent the onset of gelling, the scraper is integrated into the stirring vessel in such a way that it slides along an inner wall of the stirring vessel when rotated.

In an embodiment of the stirring vessel according to the invention, which can be combined with any embodiment already mentioned and mentioned below, unless there is a contradiction, the second agitator comprises two scrapers, which are preferably positioned at opposite positions of the inner wall of the stirring vessel. It is intended that both scrapers can be rotated in the same direction around the first axis of rotation.

In an embodiment of the stirring vessel according to the invention, which can be combined with any embodiment already mentioned and mentioned below, unless there is a contradiction, each scraper comprises a plurality of pas-through openings.

The presence of pass-through openings has been shown to improve the prevention of the hot whey protein concentrate from gelling in the stirring vessel.

For all indicated ranges, the limiting values belong to the specified range.

### BRIEF DESCRIPTION OF THE FIGURES

Examples of embodiments of the present invention are explained in more detail with respect to figures, wherein

FIG. 1 shows in a block diagram a strongly schematized overview of the method according to the invention;

FIG. 2 shows in another block diagram in a schematized overview, individual method aspects of the production of a whey protein concentrate;

FIG. 3 shows in a block diagram in a schematic overview, individual method aspects of the production of a whey end product from an adjusted whey protein concentrate,

FIG. 4 shows in a block diagram, a schematized overview of individual elements of a plant for producing a whey end product, and

FIG. 5 shows a strongly schematized overview of a plant for producing a whey end product with a stirring vessel.

### DETAILED DESCRIPTION OF THE FIGURES

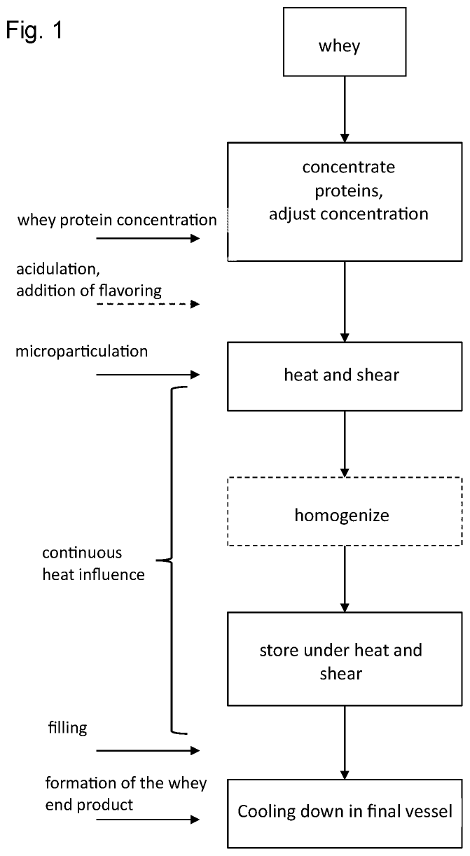

FIG. 1 shows a schematic overview of a method according to the invention in a block diagram. Therein, whey is concentrated in a single method step. In particular, the aim is to concentrate the whey proteins in order to use a desired absolute protein content of 7 wt % to 27 wt % for the subsequent method steps. Accordingly, not only are the whey proteins concentrated, but their absolute concentration in the whey protein concentrate is also adjusted, so that even with the addition of an optional acidifier and/or an optional flavoring, the desired amount of protein is used for microparticulation.

The whey protein concentrate produced and adjusted in this way is then subjected to microparticulation. The microparticulation can include one or more heat and combined shear and heat treatments, in which the whey protein concentrate is strongly sheared under the influence of continuous heat. Therein, the whey proteins are unfolded in the course of the induced denaturation, aggregation and crushing of the resulting protein aggregates into a defined particle size. After microparticulation, the whey protein concentrate is continuously kept hot until it is filled into the final vessel. The temperature of the microparticulated whey protein concentrate can be maintained at least at the denaturation temperature or higher.

Following microparticulation and before filling, homogenization of the microparticulated whey protein concentrate can optionally be carried out. Such optional homogenization can achieve further smoothing of the whey protein concentrate by adjusting the size of the protein agglomerates again. Even during optional homogenization, the whey protein concentrate is kept hot, i.e. its temperature does not fall below the denaturation temperature.

The hot, microparticulated and optionally homogenized whey protein concentrate is fed into a receiving vessel for filling. It can be stored in the receiving vessel until the actual filling. The requirement is that it is also ensured during storage that the whey protein concentrate does not cool below the denaturation temperature in the receiving vessel.

In addition, the whey protein concentrate, which is still hot, is stirred in the receiving vessel. This prevents gelation from being triggered in the receiving vessel.

Gelation is only permitted when the hot whey protein concentrate has been filled, as both the influence of heat and stirring are eliminated in the final vessel. Due to the cooling in the final vessel and the lack of movement, the whey protein concentrate gels and becomes solid. The gelled whey protein concentrate then forms the ready-to-eat whey end product.

Depending on the protein content in the whey end product and its temperature at the time of filling, gelation can be completed after about 3 to 7 minutes, for example.

Whether the whey protein concentrate could be processed into a gelled whey end product according to the invention can, as previously presented, be determined on the basis of the sensory consistency categories 1 to 4 on the end product itself, in particular visually and haptically. A rheometric determination of a gel cannot practicably be carried out on the end product itself.

It has been found that the absolute protein content in the whey protein concentrate to be processed has an important influence on the gelling behavior and thus on the achievement of the desired gelation. The following graph shows measurements of the gelation behavior of different whey protein concentrates with the same dry matter (19 wt %) but differently adjusted absolute protein content (15.5 wt %, 13.7 wt %, 12.6 wt % and 11.3 wt %). The four different whey protein concentrates were adjusted from the same raw material by dilution with pure water to the different absolute protein contents and standardised with regard to their dry matter.

The effect of the absolute protein content on the storage module G′ was measured at continuous heating (about 2 °C per min) from 50 °C to 90 °C.

### FIG. 6

The storage module G′ describes the entire viscoelastic behavior of a sample. In combination with the loss modulus G″, it characterizes the rheological properties of a sample. The loss modulus G″ describes the fluid behavior and was not measured here. The physical unit of the storage module G′ is Pascal (Pa).

When looking at milk or whey, one speaks of a gel if the storage module G′>1 Pa. In the sense of the present invention, a gel is formed according to the invention (and thus sensorially (haptically and optically) perceptible as a gel and can be divided according to the consistency categories) if the storage module G′≥50 Pa. According to the invention, the whey protein concentrate must therefore be adjusted in such a way that it achieves a Pa≥50.

The graph shows that with a higher absolute protein content, a storage modulus G′ of 50 Pa is reached already at lower temperatures.

It has been shown that temperature in particular is an efficient lever, for example, to correct the effects on gel formation caused by additives such as sweeteners or fruit preparations and also to influence the degree of gel formation.

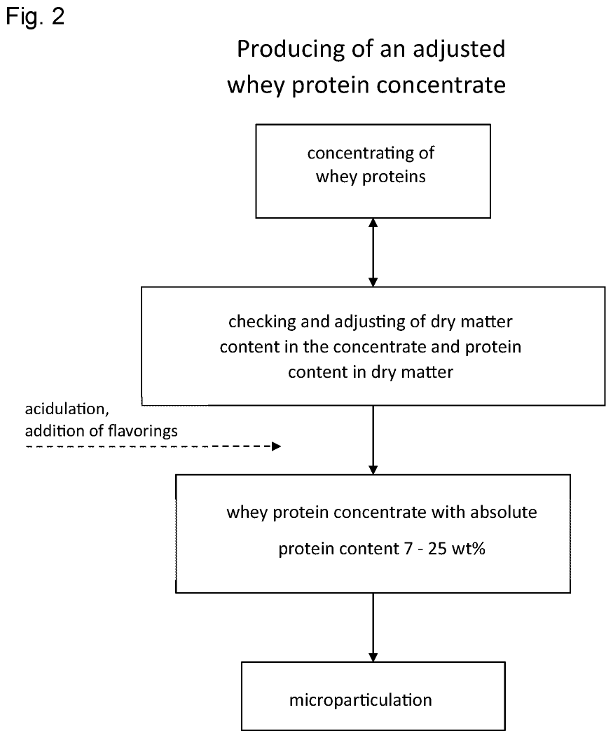

FIG. 2 shows in a further block diagram in a schematized overview individual method aspects in the production of a whey protein concentrate. A whey provided is concentrated to a whey protein concentrate by means of a suitable method. This can be, for example, ultrafiltration in combination with diafiltration, or one or more other concentration methods. The concentration method increases both the proportion of whey proteins in the dry matter and the proportion of dry matter in the whey protein concentrate. For this purpose, the proportion of whey proteins in the dry matter as well as the proportion of dry matter in the concentrate is checked and adjusted in order to obtain an absolute protein content in the concentrate in a range of 7 to 27 wt %.

Adjusting the protein concentration can, if needed, be done while taking into account the proportions of an optional acidifier and/or an optional flavoring. The aim is to adjust to an absolute protein content of between 7 and 27 g in 100 g of whey protein concentrate used, or, if acidifiers and/or flavorings are added to the whey protein concentrate for microparticulation, to adjust to 7 to 27 g of protein per 100 g of the resulting whey protein concentrate mixture. The so adjusted whey protein concentrate or the corresponding whey protein concentrate mixture is then fed into the microparticulation method.

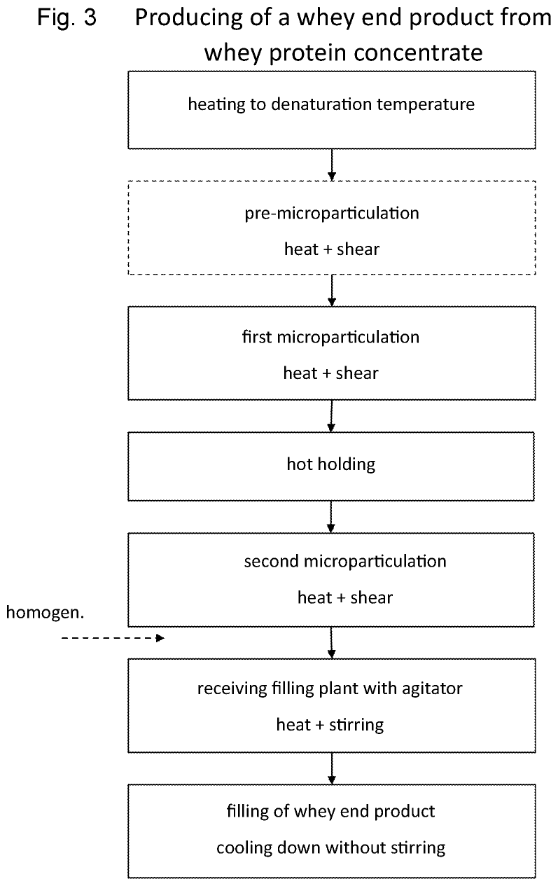

In FIG. 3 a block diagram in a schematic overview of individual method aspects of the production of the whey end product from an adjusted whey protein concentrate is shown. The adjusted whey protein concentrate (or whey protein concentrate mixture) is first heated. Advantageously, it is heated to a temperature that corresponds to the denaturation temperature or deviates only slightly from it. The denaturation temperature is arbitrarily set here at 60 °C, as discussed earlier. The heating temperature is ideally in a temperature range of 50 °C to 70 °C, more generally discussed in a temperature range of 50 °C to 95 °C. A suitable heating temperature for a whey protein concentrate WPC 80 with a dry matter content of 23 wt %, acidulated to a pH of 5.1 and 15 wt % of a flavor in the whey protein concentrate mixture may be in the range of 60 °C+/−3 °C. Heating can be carried out, for example, in a plate heat exchanger, which is considered part of the microparticulation plant.

After heating, pre-microparticulation can optionally be carried out. This can be a combined heat and shear treatment, which is carried out at a temperature of 65 °C, for example. Deviating temperatures can alternatively be chosen as discussed. A suitable scraper rotational speed can be for the above WPC 80 at 500 rpm and a output of 200 L/h.

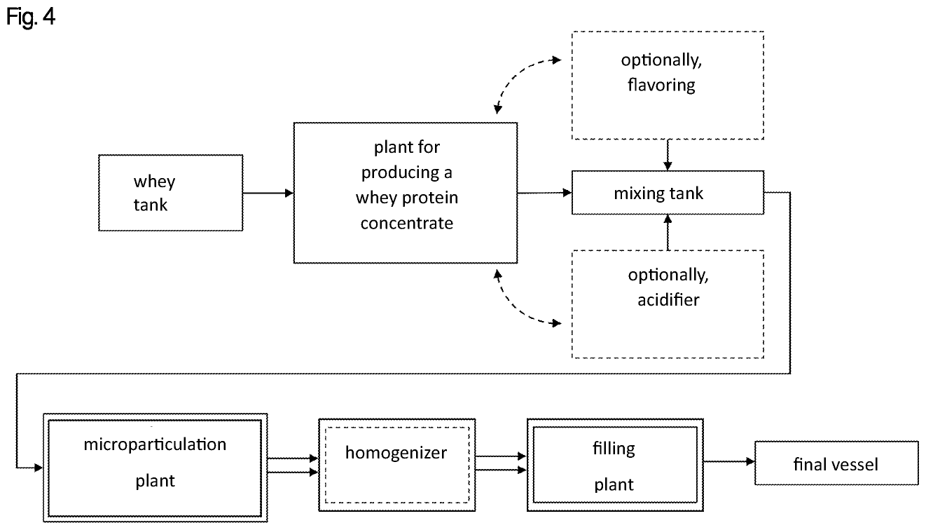

This is followed by a first microparticulation, in which the now heated whey protein concentrate or the heated whey protein concentrate mixture is exposed to a combination of heat and shear. This is typically done in a first scraped surface heat exchanger, as mentioned in FIG. 4, for example. A suitable temperature to which the whey protein concentrate mixture mentioned above exemplarily is heated can be in a range of 75 °C to 82 °C, specifically 79 °C, for example. A suitable scraper rotational speed here is 500 rpm with an output of 200 L/h.

The resulting whey protein concentrate mixture is now transported, for example, via a pipeline to a second scraped surface heat exchanger to the location of the second microparticulation. The pipeline is designed as a hot holding section in which it is ensured that the still hot whey protein concentrate mixture from the first scraped surface heat exchanger does not cool below a certain temperature. In this example, the hot holding section is designed in such a way that the whey protein concentrate mixture from the first microparticulation does not fall below the denaturation temperature. This can be achieved by a combination of the temperature of the first scraped surface heat exchanger before the hot holding section and the throughput (output) of whey protein concentrate (mixture) in L/h. For the whey protein concentrate mixture mentioned above exemplary, the hot holding temperature can be 79 °C, for example, for a pure whey protein concentrate WPC 80 with 23 wt % it can be 75 °C. For example, with a throughput of 200 L/h, the hot holding time can be 60 sec. In this constellation, the hot holding time can be in the range of 60 sec to 120 sec. If the throughput and/or temperature changes, the hot holding time can be a few seconds, e.g. 10 sec, to 400 sec or more.

The whey protein concentrate (mixture) is transported via the hot holding section to the second scraped surface heat exchanger and subjected to a second microparticulation. This means that in this second scraped surface heat exchanger, the temperature of the whey protein concentrate (mixture) is also kept above the denaturation temperature and the liquid is subjected to a shear treatment. This keeps the whey protein concentrate (mixture) liquid and gellable. This second microparticulation can be particularly advantageous if after protein denaturation in the first scraped surface heat exchanger and the aggregation of the unfolded proteins large aggregates have formed in the hot holding section. By means of this second microparticulation, more uniform protein aggregates in the liquid can be achieved in terms of size.

For the whey protein concentrate mixture mentioned above as an example, a suitable microparticulation temperature can be 75 °C at a rotational speed of 500 rpm and a throughput of 200 L/h.

In terms of the gelation to be achieved, it can be said that the faster the scraper turns, the thicker the whey protein concentrate becomes, and the stronger the degree of gelation in the final whey product.

The slower the scraper turns, the later the gelling begins, and the lower the degree of gelation achieved in the whey end product.

Temperature also has an influence: the higher the temperature, the higher the degree of gelation achieved in the whey end product, and the lower the temperature, the lower the degree of gelation achieved. For example, a lower temperature can be compensated for by a longer treatment time and vice versa. Overall, however, the temperature is limited downwards in order to meet microbiological requirements, for example. For example, pasteurization is not necessary immediately before filling, as the treatment temperature is high (above the denaturation temperature) throughout the entire process from microparticulation onwards, thus having an inherent pasteurization effect.

Finally, the absolute amount of protein used also has an influence on the degree of gelation achieved in the whey end product: the more protein used, the thicker the whey protein concentrate becomes, and the higher the degree of gelation achieved.

Conversely, the less protein is used, the lower the degree of gelation in the whey end product.

Through the interaction of the protein content used, selected temperature and scraper rotational speed, the degree of gelation of the whey end product and thus its consistency (e.g. in terms of firmness, liquefaction) can be specifically influenced.

Accordingly, during the production of the whey end product, the consistency can be influenced purely by adjusting these parameters, and the addition of thickeners, for example, can be dispensed with.

After the second microparticulation, homogenization of the microparticulated whey protein concentrate (mixture) can optionally be carried out. Such homogenization can have an additional effect on the firmness of the whey end product. Thus, by applying a homogenization pressure, a smoothing of the whey end product could be achieved. A lower homogenization pressure leads to a rather lower gelation, while a higher homogenization pressure leads to a stronger gelation. A lower homogenization pressure is understood to be a pressure of 50 bar. Good gelation could be achieved at a higher homogenization pressure of up to 250 bar, wherein the homogenization pressure can also be determined, for example, by the homogenizer used.

After the second microparticulation or after the optional homogenization, the microparticulated whey protein concentrate (mixture) is transferred to a receiving vessel without the whey protein concentrate being cooled below the denaturation temperature. Instead, the temperature of the whey protein concentrate is maintained at least at or above the denaturation temperature. The receiving can be part of a filling plant and includes an agitator. The agitator is necessary to prevent gelling of the hot whey protein concentrate in the receiving before filling. It turned out that the better the stirring, the longer the hot whey protein concentrate can be stored in the receiving container. The use of a double agitator that can be rotated in opposite directions has proven to be particularly advantageous.

The receiving vessel does not have to be actively heated. It may be provided that it is preheated before the first whey protein concentrate is poured, while it undergoes inherent tempering when liquid is continuously removed by filling, but hot liquid from microparticulation or homogenization runs back in.

The still hot whey protein concentrate (mixture) is then filled from the receiving vessel into a final vessel. It then cools down in the final vessel without undergoing any further stirring. This now allows the whey protein aggregates to gel. For example, for the above-mentioned recipe, complete gelling to the whey end product has been observed within 5 minutes.

Table 1 shows exemplary recipes based on a WPC 80 with different absolute protein contents in wt % (Prot. abs.), different fat contents (F) in g, different dry matter contents in wt % (TS), different flavor preparations in wt % (GS), at different acidulations and pH values (final mixture) as well as different settings, especially in microparticulation, such as heating temperature in °C (AW), rotational speed of the scraper used (DZ-S) in rpm in the pre-microparticulation (VMP), first microparticulation (1st MP), second microparticulation (2.MP), as well as the respective temperatures of the VMP, 1.MP, and 2.MP in °C, the hot holding time (HHZ) in °C, as well as an optional homogenization (HOM) in bar. In addition, for the individual examples, the gel consistency of the whey end product achieved in each case is according to the previously mentioned consistency categories (CC). A plant with an output of 200 L/h was used.

TABLE 1

| | [symbol] in | Prot. [symbol] | [symbol] in | Des [symbol] WPC | | Des [symbol] | | | [symbol] in | [symbol] in | [symbol] in | [symbol] in | HH [symbol] in | [symbol] in | [symbol] in | |
|---|---|---|---|---|---|---|---|---|---|---|---|---|---|---|---|---|
| Nr. | [symbol] | in [symbol] | [symbol] | 80 in % | [symbol] | in % | Acid | pH | °C | [symbol] | °C | °C | [symbol] | °C | bar | [symbol] |
| [symbol] | 1.77 | [symbol] | 21.95 | 90 | M/P | 10 | K | 5.32 | [symbol] | 131 | [symbol] | 72 | 60 | [symbol] | 100 | 0 |
| [symbol] | 2.85 | [symbol] | [symbol] | 56 | M/P | 14 | K | 4.9 | 60.5 | 500 | 64.1 | [symbol] | 60 | 74.5 | — | 0 |
| [symbol] | [symbol] | [symbol] | [symbol] | [symbol] | M/P | [symbol] | K | [symbol] | [symbol] | 400 | [symbol] | [symbol] | 80 | [symbol] | 100 | 0 |
| 64 | 1.0 | 18.59 | [symbol] | 87.5 | 5 | 12.5 | K | 5.1 | [symbol] | 500 | [symbol] | 75 | 80 | [symbol] | — | 1 |
| 70 | 1.9 | 18.59 | 22.81 | 100 | [symbol] | — | K | [symbol] | [symbol] | [symbol] | [symbol] | 75 | 60 | 72.5 | — | 1 |
| 58 | 2.85 | [symbol] | [symbol] | 56 | M/P | 14 | K | 4.9 | 60 | 500 | 85 | 72 | 60 | 89 | 100 | 2 |
| 65 | 1.9 | 18.59 | [symbol] | 86 | 5 | 14 | K | 4.9 | [symbol] | 500 | [symbol] | 72 | 80 | 89 | 100 | 2 |
| [symbol] | [symbol] | [symbol] | 21.67 | 93.5 | M/P [symbol] | 6.1 | [symbol] | 4.9 | [symbol] | 500 | 65 | 75.4 | [symbol] | 72.5 | 100 | 2 |
| 146 | 1.78 | 17.12 | 21.44 | [symbol] | M/P [symbol] | [symbol] | [symbol] | 4.9 | 60 | 500 | 65 | [symbol] | 60 | [symbol] | 100 | 2 |
| 172 | 1.81 | 17.83 | [symbol] | [symbol] | M/P [symbol] pH [symbol] | [symbol] | [symbol] | 5.2 | 60 | [symbol] | [symbol] | [symbol] | [symbol] | 78.4 | 100 | 2 |
| [symbol] | 2 | 17.35 | 21.67 | [symbol] | [symbol] | 16.5 | [symbol] | [symbol] | 59.6 | 500 | 65.9 | 77.3 | 60 | 74 | [symbol] | 3 |
| [symbol] | [symbol] | [symbol] | 21.67 | 95 | [symbol] | 5 | [symbol] | 5.0 | 58.8 | 500 | 63.6 | 76.5 | 60 | 73.5 | 100 | 3 |
| 138 | 2 | [symbol] | [symbol] | 63 | 5.2 | 17 | [symbol] | 5.0 | [symbol] | 500 | [symbol] | 79.6 | 60 | 78.7 | 100 | 3 |
| 134 | 2 | 17.35 | 21.67 | 100 | [symbol] | — | [symbol] | [symbol] | [symbol] | 500 | [symbol] | 74.9 | 80 | 71 | 100 | 3 |
| 164 | 2.02 | [symbol] | [symbol] | 50 | S, [symbol] , Ca, Mg | 20 | [symbol] | 5.6 | 59.4 | 500 | [symbol] | [symbol] | [symbol] | [symbol] | 100 | 3 |
| 172 | [symbol] | 17.63 | [symbol] | 81 | M/P [symbol] pH 5.5 | 19.4 | [symbol] | [symbol] | 59.7 | 500 | 65 | 82 | 60 | [symbol] | 100 | 3 |
| [symbol] | [symbol] | [symbol] | 25.3 | [symbol] | M/P | 12.3 | K | 4.9 | 59.2 | [symbol] | 64.4 | [symbol] | 60 | [symbol] | — | 4 |
| 181.1 | 2 | 17.35 | [symbol] | [symbol] | M/P [symbol] | [symbol] | [symbol] | 4.9 | [symbol] | [symbol] | [symbol] | [symbol] | 60 | 74 | 100 | 4 |
| [symbol] | 2 | [symbol] | [symbol] | [symbol] | [symbol] | [symbol] | [symbol] | [symbol] | [symbol] | 500 | [symbol] | 79.6 | 60 | [symbol] | 100 | 4 |

Legend:
Prot. abs.: protein absolute
M/P: mango/passion fruit
N.s: nature acidulated
ZSK: lemon juice concentrate
DZ-S: rotational speed scraper
HHZ: hot holding time
TS: dry matter
S: chocolate
Ca: calcium
ZS: citric acid
VW-T: preheating temperature
HOM: homogenization
Dos.: dosing
Z: sugar
Mg: magnesium
K: bacteria culture
MP-T: microparticulation temperature
KK: consistency category
GS: flavoring
Sw: sweetener
Acid: acidulation type
AW-T: heating temperature [symbol]
indicates data missing or illegible when filed

Table 1 shows the categorization according to the consistency categories introduced here. The consistency categories 1 to 4 correspond to whey end products according to the invention. Consistency category 0 refers to a whey end product that is liquid, comparable to a yoghurt drink. This category corresponds to an end product from a non-invention production.

FIG. 4 shows in a strongly schematized block diagram one of the various individual steps in an exemplary plant for producing a whey end product from a whey provided. The various plant elements can be seen. Arrows with a continuous line show the movement of the whey within the plant. In particular, those sections in which the whey protein concentrate in particular is moved hot, i.e. at a higher temperature, e.g. above 60 °C, are marked by a double arrow. Similarly, those plant elements in which the whey protein concentrate or the mixture in particular are hot-processed are shown with a double frame.

Hot is preferably understood to be above 60 °C, for example over 65 °C. Hot or hot keeping can be active or passive. When actively heated or kept hot, heat is actively supplied to the whey protein concentrate from the outside, for example via heating elements. Passive hot holding means that measures have been taken to ensure that an already hot whey protein concentrate releases as little temperature as possible into the environment during movement in the plant or processing in a plant element, or at least does not cool down below a certain temperature. An active cooling step of the whey protein concentrate is excluded in connection with the present invention. Only after filling into the final vessel is cooling allowed, which then leads to the end product.

Whey can be provided in a whey tank for the method according to the invention. It is fed via pipes into a plant for the production of a whey protein concentrate. Depending on the desired degree of concentration, this may include an ultrafiltration plant or diafiltration plant or similar, or a combination of such plants, as mentioned above.

The whey protein concentrate produced can then be transferred to a mixing tank, where it can also be stored. In the mixing tank, the optional acidulation and the optional mixing with one or more flavorings, if any, are then carried out. If the whey protein concentrate is to be acidulated and, if necessary, flavorings added, this is done in coordination with the concentration to be achieved and the absolute protein content to be used in the whey protein concentrate or the resulting whey protein concentrate mixture. This is indicated by the curved, dashed arrows.

From the mixing tank, the whey protein concentrate or whey protein concentrate mixture is transferred to a microparticulation plant. In the following, the term whey protein concentrate is used in particular, even if it is in a mixture with an acidifier and/or one or more flavorings.

The microparticulation plant comprises at least one heater, two or optionally three scraped surface heat exchangers and a hot holding section that fluidically connects the two scraped surface heat exchangers with each other.

The heater can be, for example, a plate heat exchanger with which the whey protein concentrate is heated to the heating temperature. From this point on, the whey protein concentrate is kept actively or passively at at least the heating temperature, preferably at least the denaturing temperature, as indicated by the double frame and the double arrows. In contrast to the prior art, cooling down of the whey protein concentrate after microparticulation does not occur.

In the microparticulation plant, the heating described above, the combined shearing and heat treatments as well as the intermediate hot holding take place. The microparticulation system can be designed to perform two or even three combined shear and heat treatments.

If homogenization is planned, the microparticulated whey protein concentrate is transferred hot from the microparticulation plant to a suitable homogenizer. A commercially available homogenizer can be used for this purpose, provided that a minimum pressure of 50 bar, preferably 100 bar, can be applied. The optional homogenization is carried out on the still hot whey protein concentrate and is designed plantwise in such a way that the whey protein concentrate is fed still hot from the homogenizer into the filling plant.

The filling system comprises at least one receiving vessel with an agitator. It is particularly advantageous if the agitator is designed as a double agitator, wherein the agitators can be rotated in opposite directions to each other. It has been shown that such a double agitator can successfully prevent the premature gelling of the hot whey protein concentrate in the receiving vessel. This is particularly successfully prevented if one of the agitators scrapes along the inside of the receiving vessel. A double scraper may be provided as described above. Such scrapers have an additional good effect if they themselves have a number of flow-though holes, with which an additional flow effect can be achieved. Such holes may be provided on one or both scrapers over the entire height of the receiving vessel.

An additional flow effect is particularly advantageous if the whey protein concentrate used has a rather high absolute protein content, and a strong gelation is to be produced in the whey end product at a higher temperature.

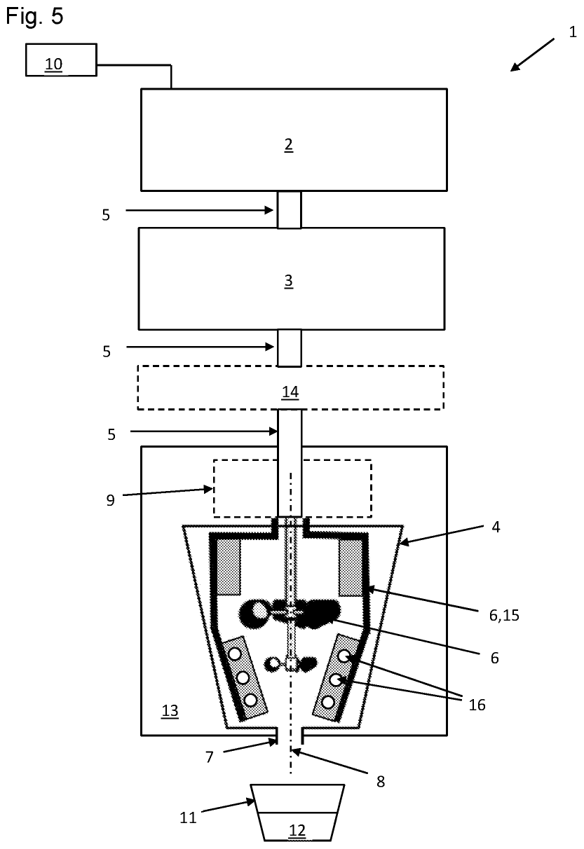

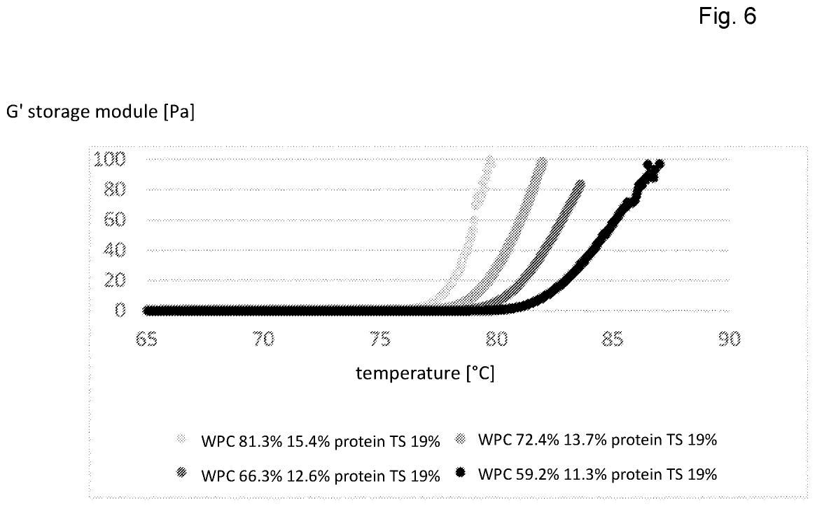

FIG. 5 shows a highly schematized overview of a plant 1 for producing a whey end product 12 with a stirring vessel 4. A control system 10, the device 2 for producing of a whey protein concentrate, the device 3 for microparticulation and the pipelines 5 are shown in a highly schematized way, while the stirring vessel 4 is shown in more detail. The stirring vessel 4 is designed to prevent gelling before filling into the final vessel 11. This can be done by means of agitator 6, as well as by adjusting the flow rate to keep the stay time in the stirring vessel short (this prevents the temperature of the whey protein concentrate in the stirring vessel from dropping too much).

In particular, the two different agitators 6 can be seen, whose respective rotation axes 8 run identically (see dotted line). The agitator 6, which is located in the middle of the stirring vessel 4, is designed as a cup agitator. Here an embodiment with two “cup levels” can be seen. The second agitator comprises two scrapers 15. Preferably, although not shown here, each scraper 15 is adapted to the inner wall of the stirring vessel in such a way that it scrapes along the inner wall of the stirring vessel when it rotates by means of a drive 9 in the stirring vessel 4. The scraper 15 shown here are wing-like. It may be provided that the scraper 15 has a distance to outlet 7 on the inside.

By rotating the agitators 6 in the stirring vessel 4 around the axis of rotation 8, the hot, microparticulated whey protein concentrate is mixed. It may be envisaged that the concentrate will be circulated in stirring vessel 4 without any air being drawn in. For further improvement, passage openings 16 are provided in the two lower wings of the scrapers 15, which can be used to achieve even more uniform mixing of the hot whey protein concentrate in the stirring vessel 4. In combination with the double cup agitator, an overall uniform mixing of the gellable whey protein concentrate is achieved, so that little or almost no gel lumps can form in the stirring vessel 4 before filling.

As soon as the whey protein concentrate has been filled from outlet 7 of stirring vessel 4 into final vessel 11, the whey protein concentrate is not moved in the final vessel and cooling is permitted. This allows the gelation to the whey end product 12 to take place in the final vessel 11.

In the context of the present invention, relative indications such as high or low protein content, high or low temperature, high or low scraper rotational speed or similar refer to data which are in the specified suitable ranges.

In the receiving vessel the whey protein concentrate is still kept at a temperature above the denaturation temperature. As mentioned before, it can be active or passive heating.

Filling is then carried out directly into a final vessel. Accordingly, there is talk of coupled production and filling. Only in the final vessel is the cooling of the whey protein concentrate allowed, and accordingly the gelling into the end product.

### LIST OF REFERENCE SIGNS

1 Plant for producing a whey end product
2 Device for producing a whey protein concentrate
3 Device for microparticulation
4 Stirring Vessel
5 Pipelines
6 Agitator
7 Outlet
8 Axis
9 Agitator drive
10 Control system
11 Final vessel
12 Whey end product
13 Filling device
14 Homogenizer
15 Passage openings

1. A method for producing a jellied whey end product, which comprises the following steps:
producing a whey protein concentrate from a whey, wherein the whey protein concentrate is adjusted to an absolute protein content which is in the range of 7 wt % to 27 wt % by weight of the whey protein concentrate,
performing a microparticulation treatment, comprising the following steps:
performing the first combined shear and heat treatment at a first microparticulation temperature of 60 °C to 95 °C under continuous shear,
hot holding of the whey protein concentrate from the first shearing and heat treatment at the hot holding temperature in a range of 60 °C to 95 °C and for a hot holding time of 10 sec to 400 sec,
performing a second combined shear and heat treatment at a second microparticulation temperature of 60 °C to 95 °C under continuous shear, and
wherein the procedure comprises the following steps:
transferring the hot whey protein concentrate to a receiving vessel with an agitator, and continuously stirring and hot holding the hot whey protein concentrate in the receiving vessel,
filling of hot whey protein concentrate from the receiving vessel into a final vessel, and cooling down of the whey protein concentrate in the final vessel to form a jellied whey end product.

2. The method of claim 1, wherein the whey is a sweet whey.

3. The method according to claim 1, wherein the whey protein concentrate is produced by a method selected from ultrafiltration, diafiltration, microfiltration and ion chromatography, or a combination thereof.

4. The method according to claim 1, wherein the first combined shear and heat treatment is carried out in a first scraped surface heat exchanger at a scraper rotational speed in a range of 100 rpm to 1200 rpm at a throughput in a range of 150 L/h to 600 L/h, and that the second combined shear and heat treatment is carried out in a second scraped surface heat exchanger at a scraper rotational speed in a range of 100 rpm to 1200 rpm with a throughput in a range of 150 L/h to 600 L/h.

5. The method according to claim 1, wherein the first microparticulation temperature is in a range of 69 °C to 89 °C.

6. The method according to claim 1, wherein the first microparticulation temperature and/or the second microparticulation temperature and/or the hot holding temperature differ from each other by a maximum temperature range of 10 °C.

7. The method according to claim 1, wherein the microparticulation treatment additionally comprises:
performing a pre-micropistulation which comprises a combined shear and heat pre-treatment after heating the whey protein concentrate to the denaturation temperature and before performing the first combined shear and heat treatment, wherein the pre-microparticulation is performed at a pre-treatment temperature between 60 °C and 95 °C under continuous shear.

8. The method of claim 7, wherein the pre-treatment temperature differs
by a maximum temperature range of 10 °C from the denaturation temperature, and/or
from the first microparticulation temperature by a maximum temperature range of 20 °C.

9. The method according to claim 1, wherein the whey protein concentrate is homogenized after microparticulation and before transfer to the receiving vessel.

10. The method according to claim 1, wherein the whey protein concentrate from microparticulation is kept at a temperature in a range of 60 °C to 95 °C until transferring it to the receiving vessel.

11. The method according to claim 1, wherein the absolute protein content of the whey protein concentrate is adjusted depending on of the protein content in the dry matter (g/100 g dry matter) and the proportion of dry matter in the whey protein concentrate, wherein the protein content in dry matter is in a range of 60 wt % to 95 wt %.

12. The method according to claim 1, wherein the absolute protein content of the whey protein concentrate is in a range of 10 wt % to 20 wt %.

13. The method according to claim 1, wherein the whey protein concentrate is acidulated to a pH between 3 and 6.5 prior to microparticulation treatment, wherein acidulation is effected by the addition of an acidifier.

14. The method according to claim 1, wherein one or more flavorings are added to the whey protein concentrate prior to microparticulation, wherein the flavorings are selected from a group that comprised: sugar, sweetener, fruit puree and flavoring substances.

15. The method according to claim 14, wherein the proportion of one or more flavorings in a whey protein concentrate mixture subjected to microparticulation is between 0 wt % and 35 wt %.

16. The method according to claim 1, wherein at least the following parameters are adjusted to prepare the whey end product:
the absolute protein content in the whey protein concentrate is in a range of 7 wt % to 27 wt % of the whey protein concentrate; and/or
the dry matter content in the whey protein concentrate is in a range of 10 wt % to 30 wt %; and/or
the pH of the whey protein concentrate is in a range of 3 and 6.5, and/or
the temperatures of the microparticulation is in a range of 60 °C to 95 °C, and/or
a shear treatment, which is in a range of 100 rpm to 1200 rpm with a throughput of 150 L/h to 600 L/h.

17. A whey end product produced by a method according to claim 1.

18. A plant (1) for producing a whey end product (12) according to claim 1, which comprises:
a device (2) for producing a whey protein concentrate;
a microparticulation device (3);
a filling device (13) with a stirring vessel (4) for filling the whey end product (12); and
pipelines (5) connecting the device (2) for producing the whey protein concentrate, the microparticulation device (3) and the filling device (13) with each other in this order; and
wherein the plant (1) is configured to keep a whey protein concentrate at a temperature in a range of 60 °C to 95 °C during microparticulation until filling.

19. The plant (1) according to claim 18, comprising a homogenizer (14) arranged between the microparticulation device (3) and the filling device (13) and is connected to the microparticulation device (3) and the filling device (13) by pipelines (5).

20. A stirring vessel (4) for a plant (1) according to claim 18, comprising one or more functionally integrated agitators (6), which are each rotatable about a common axis of rotation (8).

21. The stirring vessel (4) according to claim 20, comprising two counter-rotating agitators (6), wherein a first agitator of the two counter-rotating agitators (6) is formed as a cup agitator and wherein a second agitator of the two counter-rotating agitators (6) comprises at least one scraper (15) which is rotatable about the first axis of rotation (8), wherein the scraper (15) slides along an inner wall of the stirring vessel (4) when rotating.

22. A stirring vessel (4) according to claim 21, comprising two scrapers (15), which are positioned at opposite positions of the inner wall of the stirring vessel (4).

23. An agitator (4) according to claim 21, wherein each scraper (15) comprises a plurality of passage openings (16).
